(19) United States
(12) Patent Application Publication
(10) Pub. No.: US 2002/0057736 A1
(43) Pub. Date: May 16, 2002

(54) IMAGE CODING APPARATUS AND METHOD

(76) Inventors: HIDEYUKI FUJI, OTA-SHI (JP); MAYUMI NIWA, TOKYO (JP); NOBUO ITOH, NAGOYA-SHI (JP)

Correspondence Address: PILLSBURY MADISON & SUTRO, 725 SOUTH FIGUEROA STREET, SUITE 1200, LOS ANGELES, CA, 900175443

(21) Appl. No.: 09/140,370

(22) Filed: Aug. 26, 1998

(30) Foreign Application Priority Data
Aug. 28, 1997 (JP) 9-233081

(51) Int. Cl. H04B 1/66

(52) U.S. Cl. 375/240

(57) ABSTRACT

Interlace images are separated at every field by a frame/field transforming section, and wavelet transformation is performed for every field by an interfield wavelet transforming section. Specifically, a plurality of odd or even fields in time series are determined as one group, these fields are subjected to the wavelet transformation to separate at predetermined spatial frequencies. Among the plurality of images separated at predetermined spatial frequencies, a motion vector common to the groups is calculated in view of a change with time of an arbitrary image component to perform motion compensation. The images subjected to the interfield wavelet transformation are further subjected to wavelet transformation by an intrafield wavelet transforming section so to be coded. Thus, an operational volume for calculating motion vector for the image coding is reduced, and block distortion is remedied.

### BACKGROUND OF THE INVENTION

a) Field of the Invention

The present invention relates to an image coding apparatus and image coding method, and more particularly to an image coding apparatus for forming compressed image data by performing prediction coding of an input image signal and a method thereof.

b) Description of the Related Art

For conventional systems to transmit motion picture signals, there have been developed technologies for compression coding of image signals in order to more efficiently use transmission lines. In such compression coding, transformation coding and prediction coding are generally used. In this way, spatial redundancy and time redundancy of image signals can be reduced.

For example, Japanese Patent Laid-Open Publication No. Hei 8-182001 discloses a technology for calculating a motion vector to perform prediction coding in which an input image signal is subjected to wavelet transformation to form a hierarchical image having the original image compressed to ¼ times and 1/16 times. A motion vector is hierarchically calculated based on the compressed image.

Japanese Patent Laid-Open Publication No. Hei 9-98420 discloses a technology in which an input image signal is divided into blocks to treat 64 pixels consisting of 4 horizontal pixels×4 lines×4 frames as a single three-dimensional block, and this three-dimensional block is compressed by subband coding.

However, in the technology of Japanese Patent Laid-Open Publication No. Hei 8-182001 there remains a problem that the volume of operation to calculate the motion vector remains large because the motion vector is calculated by calculating a difference between the compressed image and the previous image in time series, and the motion vector is calculated for every frame.

Also, Japanese Patent Laid-Open Publication No. Hei 9-98420 performs coding of four frames arranged in time series but still has a problem that block distortion occurs prominently when a quantizing efficiency is enhanced in view of the transmission line of a low bit rate.

### SUMMARY OF THE INVENTION

It is an object of the present invention to provide an image coding apparatus in which a volume of operation to calculate a motion vector involved in prediction coding is decreased and in which block distortion is prevented from occurring as a result of nonperformance of frequency separation in a block unit, and to provide a method thereof.

The invention relates to an image coding apparatus for compression coding and outputting input images, which comprises an interimage transforming section which treats a plurality of input images in time series as groups and separates them into a plurality of images corresponding to predetermined spatial frequency bands and a coding section which performs coding of the plurality of images output from the interimage transforming section. Processing can be made efficient by collectively processing the plurality of images in time sequence.

It may be preferable that the coding section include a detecting section to detect a motion vector according to a change with time of images corresponding to the predetermined spatial frequency bands output from the interimage transforming section. The operational processing can be simplified by detecting a motion vector common to the groups based on at least one image.

It may also be preferable that the coding section include an intraimage transforming section to further separate the images, whose motion vector has been detected, into images corresponding to the predetermined spatial frequency bands. Data compression can be performed efficiently by performing the intraimage transformation to reduce the spatial redundancy after performing the interimage transformation.

It may also be preferable that before processing the interimage transforming section treats the plurality of input images as groups that do not overlap one another. The later processing can be simplified by using a non-duplicate image (non-duplicate type base).

It may further be preferable for the interimage transforming section to comprise a filter section for separating the plurality of input images into low frequency components and high frequency components and further separating the low and high frequency components into their respective low frequency components and high frequency components. Thus, the plurality of images in time series can be uniformly separated into images corresponding to the predetermined spatial frequency bands while covering from a low frequency to a high frequency.

It may further be preferable for the interimage transforming section to include a filter section which separates the plurality of input images into low frequency components and high frequency components and further separates the low frequency components into their respective low frequency components and high frequency components. Thus, the plurality of images in time series can be separated uniformly while covering from a low frequency to a high frequency and, especially, more finely separating the low frequency components, at predetermined spatial frequency bands.

It may also be preferable for the interimage transforming section to comprise a filter section which separates the plurality of input images into low frequency components and high frequency components and further separates the high frequency components into their respective low frequency components and high frequency components. Thus, the plurality of images in time series can be separated uniformly while covering from a low frequency to a high frequency and, especially, more finely separating the high frequency components at predetermined spatial frequency bands.

The invention also relates to an image coding method for compression coding and outputting input images, which comprises a step of performing interimage transformation to separate a plurality of input images in time series into a plurality of images corresponding to predetermined spatial frequency bands as a unit of processing; and a step of coding the plurality of separated images. Processing can be effected efficiently by collectively processing as a single processing unit the plurality of images in time series.

It may be preferable for the coding step to comprise a step of detecting a motion vector according to a difference between at least one image among the plurality of images and a corresponding image in the next unit of processing; and a step of replacing a pixel value of the image corresponding to the detected motion vector with a fixed value. By collectively processing the plurality of images in time series, the processing can be effected efficiently, and data amount can be reduced by determining the pixel values uniformly to a fixed value. It is to be understood that the fixed value includes zero in addition to the value indicating invalid data.

It may further be preferable for the coding step to comprise an intraimage-transforming step of separating the replaced image corresponding to predetermined spatial frequency bands. Data compression can be effected efficiently by performing the intraimage transformation to reduce the spatial redundancy after the interimage transformation.

It may also be preferable that the interimage transforming step determines the unit of processing of input images so as not to overlap the plurality of input images one another. The later processing can be simplified by using a non-duplicate type image (non-duplicate type base).

It may also be preferable that the interimage transforming step separates the plurality of input images into low frequency components and high frequency components and further separates the low and high frequency components into their respective low frequency components and high frequency components. Thus, the plurality of images in time series can be separated uniformly from a low frequency to a high frequency at predetermined spatial frequency bands.

It may also be preferable that the interimage transfer step separates the plurality of input images into low frequency components and high frequency components and further separates the low frequency components into their respective low frequency components and high frequency components. Thus, the plurality of images in time series can be separated into images at predetermined spatial frequency bands while covering from a low frequency to a high frequency and, especially, more finely separating the low frequency components.

It may also be preferable for the interimage transforming step to separate the plurality of input images into low frequency components and high frequency components and further separate the high frequency components into respective low frequency components and high frequency components. Thus, the plurality of images in time series can be separated while covering from a low frequency to a high frequency at predetermined spatial frequencies and, especially, more finely separate the high frequency components.

It may be preferable that the interimage transforming section separates by wavelet transformation.

It may be preferable that the interimage transforming step separates the input images by wavelet transformation. The plurality of images in time sequence can be separated efficiently using wavelet transformation.

It may be preferable that the image coding apparatus further comprises a quantizing section, which quantizes by separately controlling a quantizing parameter of the high frequency images among the plurality of images corresponding to predetermined spatial frequency bands output from the intraimage transforming section.

It may be preferable that the quantizing section more roughly determines the quantizing parameter of the high frequency images as compared with the quantizing parameter of the low frequency images.

It may be preferable that the image coding method further comprises a quantizing step which quantizes by separately controlling the quantizing parameters of the high frequency images among the plurality of images corresponding to predetermined spatial frequency bands obtained by the intraimage-transforming step.

It may be preferable that the quantizing step more roughly determines the quantizing parameter of the high frequency images as compared with the quantizing parameter of the low frequency images.

Generally, the low frequency component has the greatest effect on image quality. Therefore, the quantity of code can be reduced without largely affecting the quality of a decoded image by roughly quantizing components other than the low frequency component.

### BRIEF DESCRIPTION OF THE DRAWINGS

FIG. 1 is a functional block diagram of the coding and decoding apparatus according to an embodiment of the present invention;

FIGS. 2A, 2B and 2C are explanatory diagrams showing the frame/field transforming function of the embodiment,

FIG. 2A being a diagram showing the structure of a frame,

FIG. 2B a diagram showing the structure of an odd field, and

FIG. 2C a diagram showing the structure of an even field;

FIG. 3 is a structural diagram showing an interfield wavelet transforming section;

FIG. 4 is an explanatory diagram of functions of performing interfield wavelet transformation;

FIG. 5 is an explanatory diagram of motion compensation;

FIG. 6 is an explanatory diagram of image data after the motion compensation;

FIG. 7 is a detailed functional block diagram of an intrafield wavelet transforming section;

FIG. 8 is an explanatory diagram of intrafield wavelet transformation;

FIG. 9 is a circuit diagram of an interfield wavelet transforming circuit;

FIG. 10 is a circuit diagram of another interfield wavelet transforming circuit;

FIG. 11 is an explanatory diagram of the functions of the circuit shown in FIG. 10;

FIG. 12 is a circuit diagram of still another interfield wavelet transforming circuit;

FIG. 13 is an explanatory diagram of the functions of the circuit shown in FIG. 12; and

FIG. 14 is a graph showing the relationship between a bit rate and image quality when a dead zone width is increased.

### DETAILED DESCRIPTION OF THE PREFERRED EMBODIMENT

A preferred embodiment of the invention will be described with reference to the accompanying drawings.

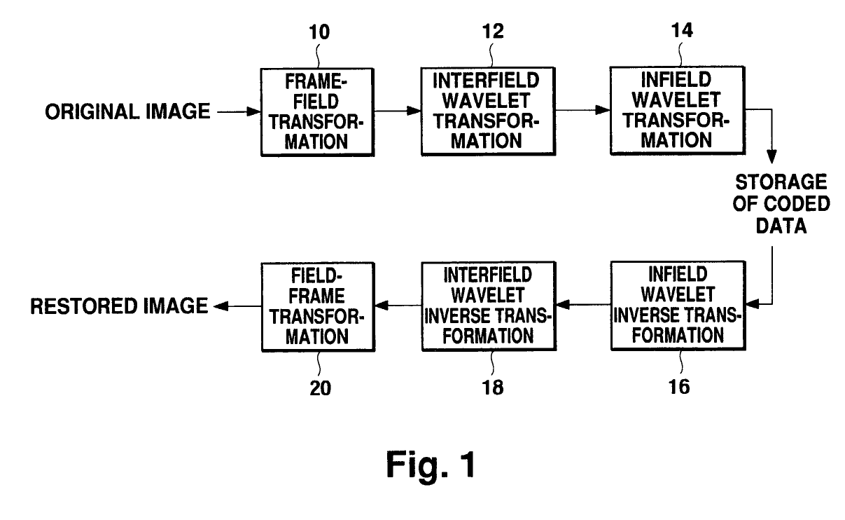

FIG. 1 is a functional block diagram of the image coding apparatus and the image-decoding apparatus according to the preferred embodiment of the present invention. The functional block of the image coding apparatus comprises a frame/field transforming section 10 which separates the frames of an interlace original image comprising odd and even fields into the odd field and the even field, an interfield wavelet transforming section 12 which performs interfield wavelet transformation of the separated odd and even fields, and an intrafield wavelet transforming section 14 which performs intrafield wavelet transformation of the image having undergone interfield wavelet transformation. The image decoding apparatus is a block having reverse functions to those of the functions of the image coding apparatus, and specifically comprises an intrafield wavelet reverse-transforming section 16 which performs intrafield wavelet reverse-transformation of the coded data, an interfield wavelet reverse-transforming section 18, and a field/frame transforming section 20 which configures the frame from the field. Coding and decoding are opposite functions. The respective functions of the image-coding apparatus will be described in detail below.

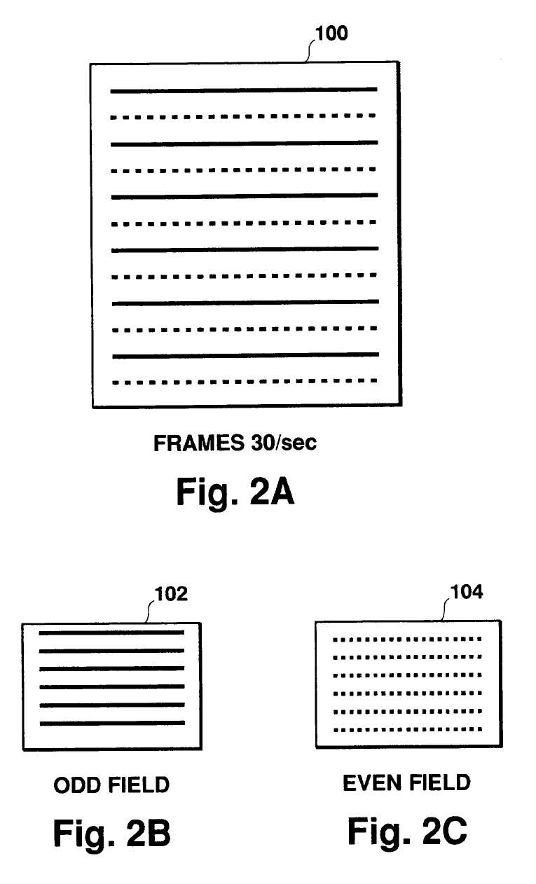

FIGS. 2A, 2B, and 2C show schematically the transforming functions of the frame/field transforming section 10. FIG. 2A shows a frame 100, which is sent at a ratio of thirty per second and comprises an odd field 102 shown in FIG. 2B and an even field 104 shown in FIG. 2C. Specifically, the odd field 120 of FIG. 2B and the even field 104 of FIG. 2C are alternately displayed at intervals of 1/60 seconds to display the frame 100 of FIG. 2A every 1/30 second. The frame/field transforming section 10 separates the frame 100 of FIG. 2A into the odd field 102 of FIG. 2B and the even field of FIG. 2C and supplies the respective fields into the next interfield wavelet transforming section 12. One frame of the interlace original image may comprise, for example, 704×480 pixels.

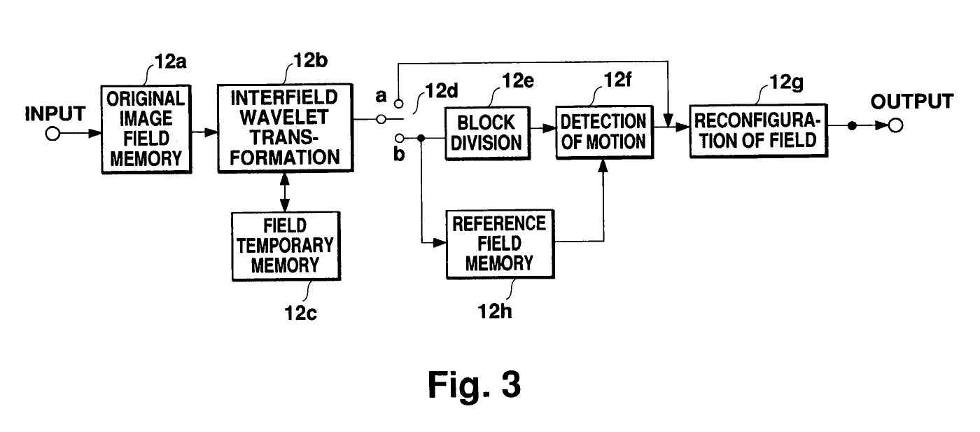

FIG. 3 shows a specific structure of the interfield wavelet transforming section 12. The odd field 102 and the even field 104 simultaneously undergo the same processing. To simplify description, the odd field 102 will be used to represent both processes.

An original image field memory 12a is a memory for storing input data up to a quantity that interfield wavelet transformation can be made and, in this embodiment, stores four odd fields, odd fields 1, 2, 3, 4. These fields are supplied from the original image field memory 12a to the interfield wavelet transforming circuit 12b. As will be described below, the odd fields 1, 2 are first processed, followed by the odd fields 3, 4. Therefore, when the odd fields are stored into the original image field memory 12a, these fields are supplied into the interfield wavelet transforming circuit 12b, and the odd fields 1, 2 can be processed while the odd fields 3, 4 are being read. When the odd fields 3, 4 have been read, they are supplied to the interfield wavelet transforming circuit 12b, and while reading the odd fields 1, 2 of the next group, the odd fields 3, 4 can be processed.

The interfield wavelet circuit 12b performs wavelet transformation using the four odd fields 1, 2, 3, 4, separates them into image components with a different spatial frequency, and outputs to a changeover switch 12d. Specific contents of the wavelet transformation will be described afterward. When the wavelet transformation is performed, the processed results are stored in a field temporary memory 12c.

The changeover switch 12d is changed depending on whether the pertinent field is subject to detection of motion. When a pertinent field is not subject to detection of motion, the changeover switch 12d is switched to contact a and outputs as it is, and when the field is subject to detection of motion, the changeover switch 12d is switched to contact b.

A block division circuit 12e is a circuit for dividing the field used for motion detection into blocks (16×16 pixels), and a motion vector is calculated for each block. The pertinent field divided into blocks is supplied to a motion detector circuit 12f.

A reference field memory 12h is a memory for storing the previous field as reference data for motion detection. And, when the odd fields 1, 2, 3, 4 are processed, the reference field memory 12h stores any of the previous four odd fields. The previous field data by one stored in the reference field memory 12h is supplied to the motion detector circuit 12f.

The motion detector circuit 12f compares the block-divided field with a reference field and calculates a motion vector by a block matching method. The block matching method will be described in detail afterward. The calculated motion vector is supplied, together with the subject field to be processed, to a field reconfiguration circuit 12g.

The field reconfiguration circuit 12g replaces all pixel values in the blocks for which the motion vector has been calculated with zero and reconfigures the field undergone the motion detection. Thus, data is compressed by replacing the pixel values in the blocks with zero.

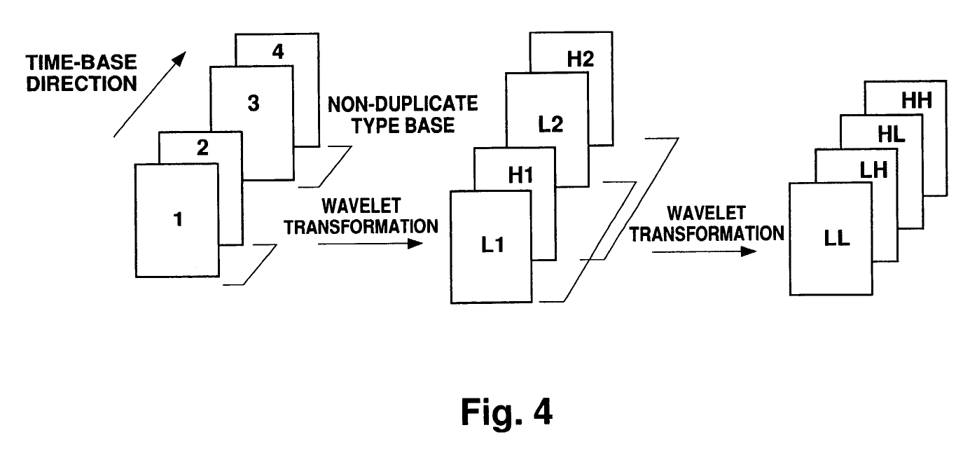

FIG. 4 shows schematically the functions of the interfield wavelet transforming section 12. Four odd fields in time series to be stored into the original image field memory 12a are shown to the left of the drawing. Specifically, they are an odd field 1 configuring one frame of the original image, an odd field 2 configuring one frame of the next original image, the odd field 3 configuring one frame of the next original image but one, and an odd field 4 configuring one frame of the next original image but two. The odd field 2 is a field after the odd field 1 in terms of time, and the odd field 3 is a field after the odd field 2 in terms of time. For these four odd fields in time series, the interfield wavelet transforming circuit 12b performs first the wavelet transformation of the odd field 1 and the odd field 2 as a set, then the odd field 3 and the odd field 4 as another set. The wavelet transformation is transformation in that an input image signal is divided into a high frequency component of a spatial frequency and a low frequency component of a spatial frequency, and both components obtained are down-sampled to remove every other sample alternately in vertical and horizontal directions. For example, separation into high and low frequencies uses a low-pass filter H0(z) and a high-pass filter H1(z). For example, they are defined by the following expressions.

H0(z)=(1+z⁻¹)/2^{0.5}

H1(z)=(1+z⁻¹)/2^{0.5}

The above expressions are known as Haar wavelets. Such filters are designed to separate the input data into high and low frequencies and to reconfigure the input data completely by a synthesis filter uniquely calculated from these filters. The wavelet transformation for dividing into the high and low frequencies is described below. The wavelet transformation with the odd field 1 and the odd field 2 as a set means that the odd field 1 and the odd field 2 are determined as a successive one-dimensional picture signal, and this one-dimensional picture signal is subjected to the wavelet transformation so to be separated into high and low frequency components. Accordingly, the obtained high and low frequency components become data with the time of the odd field 1 and the time of the odd field 2 present at the same time.

FIG. 4 shows in its center image data resulting from the wavelet transformation performed with the odd field 1 and the odd field 2 as a set and the odd field 3 and the odd field 4 as another set. In the drawing, a low frequency component and a high frequency component, which are separated by performing the wavelet transformation on the odd field 1 and the odd field 2 as a set, are expressed by L1 and H1, respectively. A low frequency component and a high frequency component, which are separated by performing the wavelet transformation on the odd field 3 and the odd field 4 as a set, are expressed by L2 and H2, respectively.

The interfield wavelet transforming circuit 12b additionally performs wavelet transformation on these high and low frequency components. Specifically, the low frequency component L1 separated from the odd field 1 and the odd field 2 is paired with the low frequency component L2 separated from the odd field 3 and the odd field 4 to perform the wavelet transformation to separate into high and low frequency components. The high frequency component H1 of the odd field 1 and the odd field 2 and the high frequency component H2 of the odd field 3 and the odd field 4 are also paired and subjected to the wavelet transformation to separate into high and low frequency components.

FIG. 4 shows the image components separated as described above. A low frequency component separated from the low frequency components L1, L2 is denoted by LL, a high frequency component separated from the low frequency components L1, L2 is denoted by LH, a low frequency component separated from the high frequency components H1, H2 is denoted by HL, and a high frequency component separated from the high frequency components H1, H2 is denoted by HH. Image data of LL, LH, HL and HH are originated from data of the odd fields 1, 2, 3, 4.

Thus, the interfield wavelet transforming circuit 12b groups the four fields in time series and, based on this group as a processing unit, separates four image components, such as LL, LH, HL and HH, having differing spatial frequencies. The image components separated at predetermined spatial frequencies are supplied to the block division circuit 12e and the motion detection circuit 12f to calculate a motion vector.

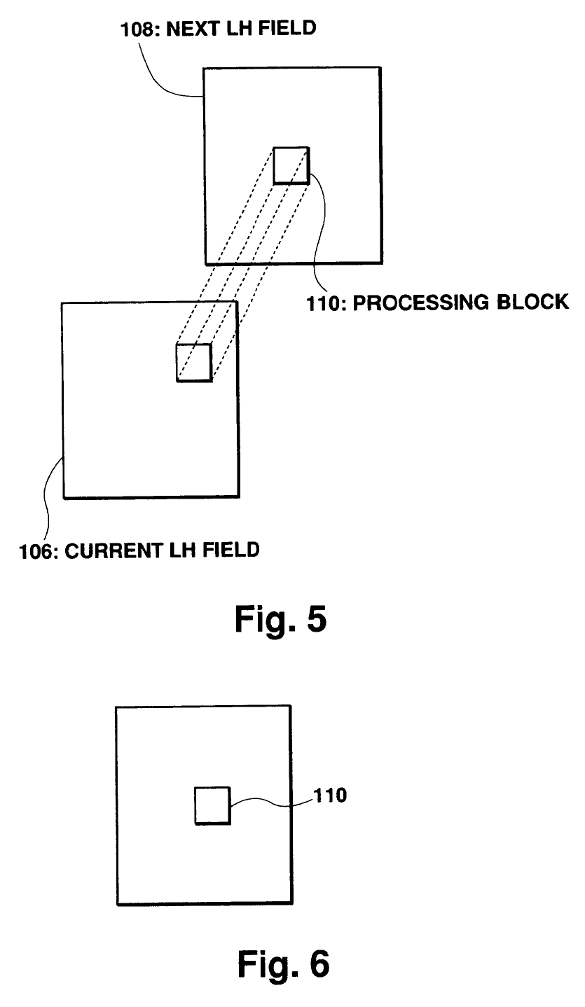

FIG. 5 is a schematic diagram showing the motion detection conducted by the motion detection circuit 12f. In the motion detection circuit 12f, an arbitrary image component is selected from the supplied four image components LL, LH, HL and HH, compared with corresponding image components in the next group in terms of time, and a motion vector is calculated by a block matching method. For example, when an LH field 106 is used as an image to calculate a motion vector, the current LH field 106 is compared with a corresponding LH field 108 of the next group, a block similar to a processing block 110 of the next LH field 108 is searched from the current LH field 106, and its displacement is calculated as the motion vector. In searching, a predetermined performance function is used to evaluate a difference value in a pixel unit, and a position having a minimum evaluation value is determined. The motion vector is calculated on every processing block. A given threshold is set as the evaluation value, and when it is satisfied, it is judged that the motion vector is calculated.

After calculating the motion vector of the next LH field 108, the field reconfiguration circuit 12g outputs all values in the processing block 110 of the LH field 108 as zero as shown in FIG. 6. The same motion vector is used on the other image components, namely LL, HL and HH, and all values in the block corresponding to the processing block position are set to zero. Thus, information is compressed.

Although the LH component was used in the above description, the image components used for the motion vector calculation may be any of LL, LH, HL and HH. But, any of LH, HL, HH excluding LL is preferably used because a motion component appears mainly on the side of a high frequency. It is also possible to select an image component having the highest similarity by calculating a motion vector in order of from the high frequency, namely in order of HH, HL, LH and LL. In addition, all the image components LL, LH, HL and HH can be used to calculate a motion vector, and the motion vectors which have the largest number of the same numeral among the four motion vectors can also be selected.

As described above, the interfield wavelet transforming section 12 makes a group of four fields, performs the wavelet transformation, calculates one motion vector on the four fields, and makes the values in the block zero, and supplies it to the intrafield wavelet transforming section 14.

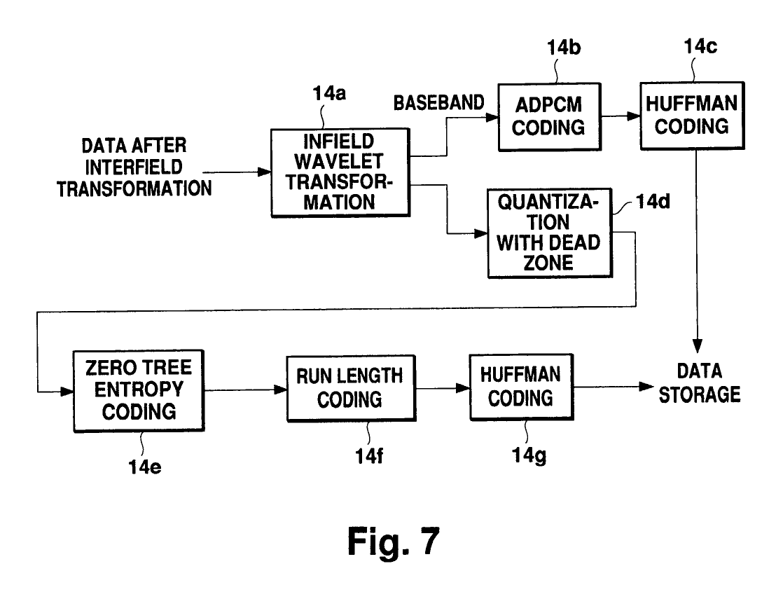

FIG. 7 is a detailed functional block diagram of the intrafield wavelet transforming section 14. The respective image components LL, LH, HL and HH after the interfield transformation are supplied to the intrafield wavelet transforming circuit 14a. The intrafield wavelet transforming circuit 14a performs the wavelet transformation of the respective image components LL, LH, HL and HH to separate into high and low frequency components as in Japanese Patent Laid-Open Publication No. Hei 8-182001. For example, when an image LL is input, it is separated into high and low frequency components by a low-pass filter HO(z) and a high-pass filter H1(z). The obtained components are down-sampled in vertical and horizontal directions alternately to remove every other sample. The low frequency component is further recursively repeated so that the above process is performed a plurality of times to further separate high and low frequency components.

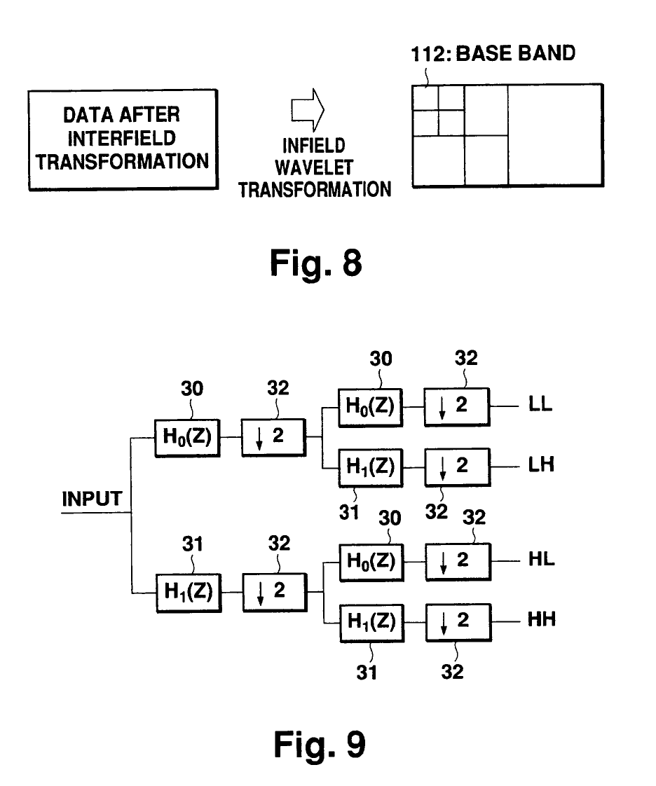

The image components separated as described above are schematically shown in FIG. 8. Data after the interfield transformation is shown in FIG. 8 and comprises a reference image component as reference for motion compensation and an image component having received the motion compensation. The image component under the motion compensation has all the values of the respective blocks of blocked matched LL, LH, HL and HH set to zero. An image after the wavelet transformation of such an image in the field is shown to the right of FIG. 8. The top left-hand corner of the figure shows an image component (base band 112) at the lowest frequency after recursively separating the low frequency component. This base band 112 is equivalent to an image resulting from reducing the original image. And, the remaining image component has a value of substantially zero. Then, after the intrafield wavelet transformation, the obtained image is separated into the base band 112 component and another component, which are then compressed by a different coding.

In FIG. 7, the base band 112, as the lowest frequency component among the images output from the intrafield wavelet transforming circuit 14a, is supplied to an ADPCM coding circuit 14b. The ADPCM coding circuit 14b is to determine a quantizing width according to a width of the differential value in DPCM which modulates to transmit a differential value of the individual pixel in the screen corresponding to the base band. Specifically, quantization is made by decreasing the quantizing width in a region that the width of the differential value is small and increasing the quantizing width in a portion that the width of the differential value is large. The base band 112 coded by the ADPCM coding circuit 14b is further supplied to a Huffman coding circuit 14c.

The Huffman coding circuit 14c allocates in descending order a code having a short code length to data having a high appearance probability in the whole data to decrease the whole code quantity, thereby compressing data. The compressed data may be stored in a storage media.

Meanwhile, components other than the base band 112 output from the intrafield wavelet transforming circuit 14a are supplied to a quantizing circuit 14d with dead zone. The quantizing circuit 14d with dead zone outputs zero uniformly without quantizing in a predetermined region in the neighborhood of zero to quantize to increase the value of data zero as a result. As described above, the components other than the base band 112 output from the intrafield wavelet transforming circuit 14a have a value of approximately zero, so that data compression can be effected efficiently by the quantization with dead zone coupled with the run length coding of a later step. Output from the quantizing circuit 14d with dead zone is further supplied to a zero tree entropy coding circuit 14e.

The zero tree entropy coding circuit 14e relates data equal to the same portion spatially in a tree structure in respective bands divided by the intrafield wavelet transformation as shown in FIG. 8. This processing is based on a fact that when data in a deeply divided hierarchy is small, data in a corresponding shallow hierarchy is also small. Thus, the data list can be transformed into a list with more zeros. Output from the zero tree entropy coding circuit 14e is supplied to a run length coding circuit 14f.

The run length coding circuit 14f performs coding of valid data and data in the quantity of zero data up to the valid data to make them into a pair of data, and if the quantity of zero data increases, it does not transmit the zero data itself but compresses data. The valid data is data other than zero. Output of the run length coding circuit 14f is further supplied to a Huffman coding circuit 14g.

The Huffman coding circuit 14g allocates in descending order a code having a short code length to data having a high appearance probability among data input in the same way as in the Huffman coding circuit 14c, thereby further compressing data. The compressed data is then stored in a storage media.

As described above, the four fields in time series are grouped as one processing unit in this embodiment, the motion vector is calculated based on an arbitrary spatial frequency component of a given group and a corresponding frequency component of the next group to perform the motion compensation, and only one motion vector is calculated for the four fields. Therefore, as compared with a case of calculating one motion vector for one field every time, the motion vector can be calculated by a small calculation quantity in this embodiment.

Since the motion vector is calculated and the image undergone the motion compensation is further subjected to the intraimage wavelet transformation to compress data, data compression can be performed very efficiently.

The interfield wavelet transformation and the intrafield wavelet transformation are performed in a field unit rather than in a block unit. Thus, coding can for the most part be effected without causing block distortion.

In the above description, coding was described with reference to an interlace image, but a non-interlace image can also be coded in the same way. In this case, four fields are not grouped for processing, but four frames in time series are grouped for processing.

As shown in FIG. 4, odd fields 1, 2, 3, 4 can be formed into one group with different odd frames 5, 6, 7, 8 are formed into the next group to make the interfield wavelet transformation, and fields belonging to the respective groups can be overlapped mutually. Specifically, it is also possible to determine odd fields belonging to a given group as odd fields 1, 2, 3, 4 and those belonging to the next group as odd fields 3, 4, 5 and 6. But, this overlap type processing has an effect on all fields, which overlap if a scene change of an image occurs, and subsequent processing to deal with the overlapping is complex. Therefore, in order to simplify the apparatus configuration, it is preferable to perform the wavelet transformation of a non-overlap type base, that the fields belonging to the respective groups do not overlap, as in this embodiment.

In this embodiment, LL, LH, HL and HH were separated at predetermined spatial frequencies from the odd fields 1, 2, 3 and 4 as shown in FIG. 4. But, it is also possible to have the odd fields 1, 2, 3 and 4 into a group and repeatedly divide the low frequency only to separate at predetermined spatial frequencies or repeatedly divide the high frequency only to separate at predetermined spatial frequencies.

FIG. 9 is a specific circuit diagram of the interfield wavelet transforming circuit 12b (see FIG. 3) used in this embodiment. In this circuit, both low and high frequencies are repeatedly divided to separate LL, LH, HL and HH as described above. Specifically, they are divided into low and high frequency components by a low-pass filter H0(z) 30 and a high-pass filter H1(z) 31. The low frequency component is down-sampled to remove every other sample by a down sampler 32, and further division is performed into low and high frequency components by the low-pass filter H0(z) 30, the high-pass filter H1(z) 31 and the down sampler 32 to separate into an LL component (low frequency side) and an LH component (high frequency side). Similarly, the high frequency component is further divided into low and high frequency components by the low-pass filter H0(z) 30, the high-pass filter H1(z) 31 and the down sampler 32 and separated into an HL component (low frequency side) and an HH component (high frequency side).

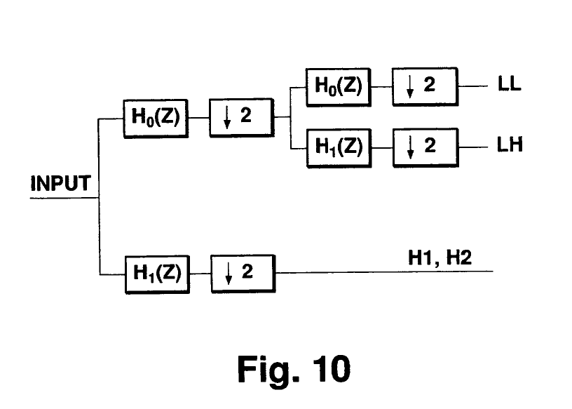

FIG. 10 is a specific circuit diagram of the interfield wavelet transforming circuit 12b when the low frequency only is repeatedly divided. In this circuit, division into low and high frequency components is performed by the low-pass filter H0(z) 30 and the high-pass filter H1(z) 31, and down sampling is made to remove every other sample by the down sampler 32. The high frequency component is output as H1 and H2 without change, while the low frequency component is further divided into low and high frequency components by the low-pass filter H0(z) 30, the high-pass filter H1(z) 31 and the down sampler 32 and separated into an LL component (low frequency side) and an LH component (high frequency side) in the same way as shown in FIG. 9. Thus, respective components LL, LH, H1 and H2 are separated.

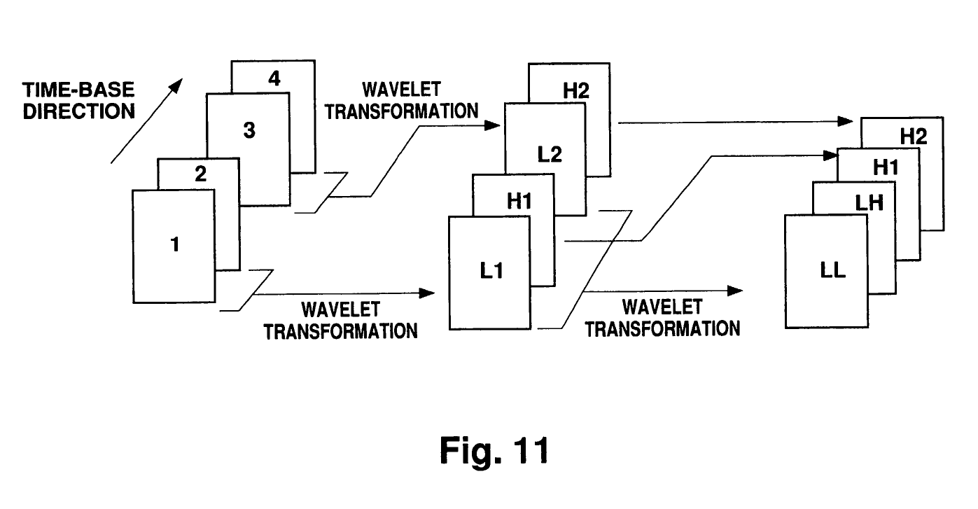

FIG. 11 is a schematic diagram of the interfield wavelet transformation using the circuit shown in FIG. 10. L1, H1, L2 and H2 are separated from four odd fields and further separated into LL, LH, H1 and H2. The point that for example, LH is used among LL, LH, H1 and H2 to calculate a motion vector is the same as in FIG. 4.

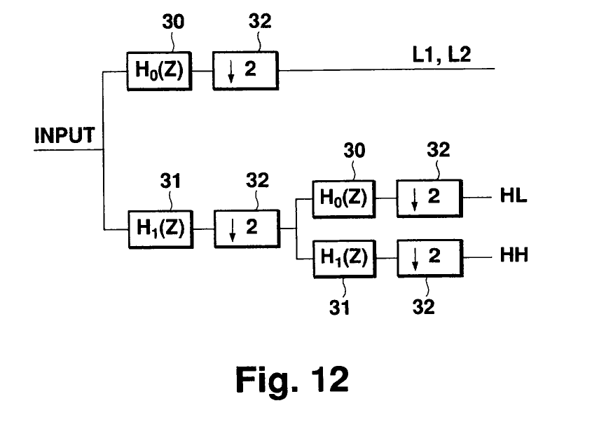

FIG. 12 is a circuit diagram of the interfield wavelet transforming circuit 12b when the high frequency only is repeatedly divided. In this circuit, the high frequency is divided into low and high frequency components by the low-pass filter H0(z) 30 and the high-pass filter H1(z) 31, then down sampled to every other sample by the down sampler 32. The low frequency components are output as L1, L2 without change, while the high frequency components are further divided into low and high frequency components by the low-pass filter H0(z) 30, the high-pass filter H1(z) 31 and the down sampler 32 and separated into an HL component (low frequency side) and an HH component (high frequency side). Thus, respective components L1, L2, HL and HH are separated.

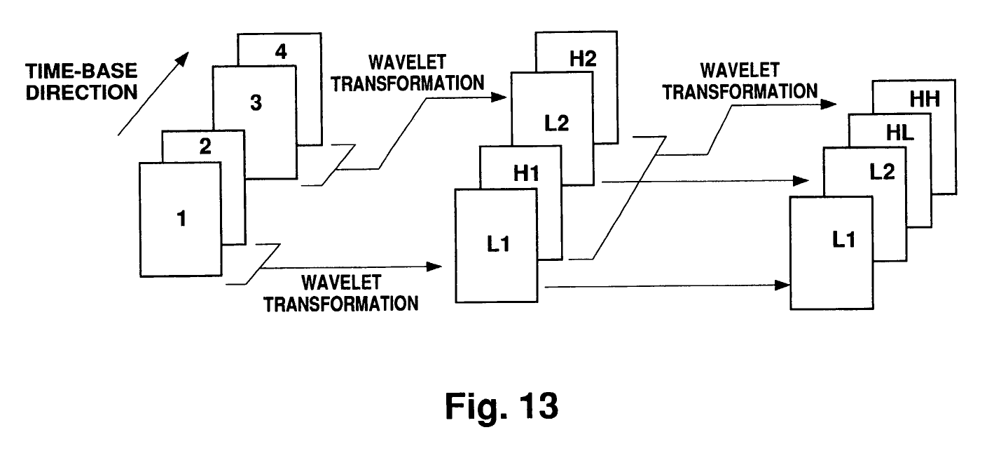

FIG. 13 is a schematic diagram of the interfield wavelet transformation by the circuit shown in FIG. 12. Among L1, L2, HL and HH, for example HH can be used to calculate a motion vector common to these components.

Although separation by wavelet transformation at predetermined spatial frequencies was described above, the present invention is not limited to the wavelet transformation but can also use any processing (e.g., subband coding, DCT, and the like) which is capable of separating the input image at predetermined spatial frequencies.

Further, the respective components LL, LH, HL and HH are subjected to the intrafield wavelet transformation in this embodiment, the base band is subjected to the ADPCM coding and then to the Huffman coding; while those other than the base band are coded by sequentially performing the quantization with dead zone, zero tree entropy quantization, run length coding and Huffman coding. The components LL, LH, HL and HH are not subjected to the same coding but at least any one of them can be quantized roughly for additional reduction of the quantity of codes.

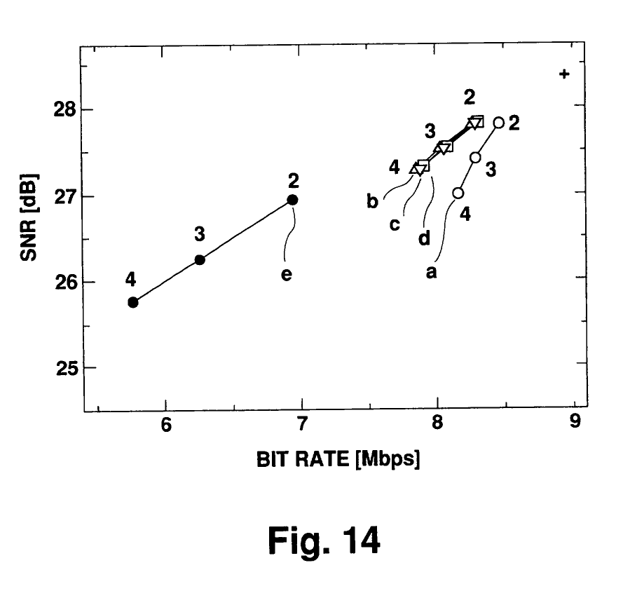

FIG. 14 shows a result of evaluation by coding any of the components LL, LH, HL and HH with a dead zone width of the quantizing circuit 14d with dead zone increased and restoring the coded image. In the drawing, the horizontal axis indicates a bit rate (quantity of generated codes bps: the number of bits which is generated each second). When the bit rate is large, the quantity of generated codes is large, indicating that the increased number of generated codes is not favorable in view of data reduction. The vertical axis indicates an S/N ratio (SNR) of a restored image and the original image. The larger the S/N ratio is, the better the image quality is. Therefore, it is desirable to get closer to the top left in the drawing, because it indicates that good image quality can be obtained with a small quantity of data.

In the drawing, a polygonal line a indicates bit rate and SNR values when a dead zone width of the component LL only is increased to 2, 3 and 4 (figures in the drawing indicate increments) with respect to a reference parameter (x in the drawing); a polygonal line b indicates bit rate and SNR values when a dead zone width of the component LH only is increased to 2, 3 and 4 with respect to the reference parameter; a polygonal line c indicates bit rate and SNR values when a dead zone width of the component HL only is increased to 2, 3 and 4 with respect to the reference parameter; a polygonal line d indicates bit rate and SNR values when a dead zone width of the component HH only is increased to 2, 3 and 4 with respect to the reference parameter; and a polygonal line e indicates bit rate and SNR values when a dead zone width of the components other than LL only is increased to 2, 3 and 4 with respect to the reference parameter. The larger the dead zone width increases, the more the data becoming zero increases, so that the quantity of codes is reduced.

It can be seen from the drawing that the polygonal line a indicates degradation of the image quality because SNR lowers heavily as the dead zone width increases, while the polygonal lines b, c, d, e indicate that the image quality is prevented from being degraded. Especially, increment 2 of the polygonal line e indicates substantially the same SNR as increment 4 of the polygonal line a, but the bit rate is small by about 1 Mbps. Thus, it is seen that a small quantity of codes and a high image quality are obtained.

As described above, when the quantization of the component LL is rough, the image quality is degraded prominently. When the components other than the component LL are quantized roughly, the quantity of codes can be reduced without causing heavy degradation of the image quality. Thus, when transmission capacity is limited, quantizing parameters of the components other than the component LL, namely at least one, and more preferably, all high frequency components are separately controlled, and the quantizing parameters are set rough as compared with the low frequency components to roughly quantize. Accordingly, a target quantity of codes can be achieved without involving degradation of the image quality.

Consequently, the present invention can reduce a quantity of calculation involved in calculation of the motion vector, perform coding without block distortion, and compress data with high efficiency.

While there have been described that what is at present considered to be a preferred embodiment of the invention, it is to be understood that various modifications may be made thereto, and it is intended that the appended claims cover all such modifications as fall within the true spirit and scope of the invention.

What is claimed is:

1. An image coding apparatus for compression coding input images and outputting images, comprising:
an interimage transforming section, which treats a plurality of input images in time series as groups and separates them into a plurality of images corresponding to predetermined spatial frequency bands; and
a coding section, which performs coding of the plurality of images output from the interimage transforming section.

2. The image coding apparatus according to claim 1, wherein the coding section includes a detecting section which detects a motion vector according to a change with time of images corresponding to the predetermined spatial frequency bands output from the interimage transforming section.

3. The image coding apparatus according to claim 2, wherein the coding section includes an intraimage transforming section which further separates the images whose motion vector has been detected into images corresponding to the predetermined spatial frequency bands.

4. The image coding apparatus according to claim 1, wherein the interimage transforming section treats the plurality of input images as groups not to overlap one another before processing.

5. The image coding apparatus according to claim 1, wherein the interimage transforming section comprises a filter section which separates the plurality of input images into low frequency components and high frequency components and further separates the resulting low and high frequency components into their respective low frequency components and high frequency components.

6. The image coding apparatus according to claim 1, wherein the interimage transforming section comprises a filter section which separates the plurality of input images into low frequency components and high frequency components and further separates the resulting low frequency components into their respective low frequency components and high frequency components.

7. The image coding apparatus according to claim 1, wherein the interimage transforming section includes a filter section which separates the plurality of input images into low frequency components and high frequency components and further separates the resulting high frequency components into their respective low frequency components and high frequency components.

8. An image coding method for compression coding input images and outputting images, comprising:
a step of performing interimage transformation to separate a plurality of input images in time series into a plurality of images corresponding to predetermined spatial frequency bands as a unit of processing; and
a step of coding the plurality of separated images.

9. The image coding method according to claim 8, wherein the coding step comprises:
a step of detecting a motion vector according to a difference between at least one image among the plurality of images and a corresponding image in the next unit of processing; and
a step of replacing a pixel value of the image corresponding to the detected motion vector with a fixed value.

10. The image coding method according to claim 9, wherein the coding step has an intraimage-transforming step of separating the replaced image corresponding to predetermined spatial frequency bands.

11. The image coding method according to claim 8, wherein the interimage transforming step determines the unit of processing of input images so not to overlap the plurality of input images one another.

12. The image coding method according to claim 8, wherein the interimage transforming step separates the plurality of input images into low frequency components and high frequency components and further separates the low frequency and high frequency components into low frequency components and high frequency components respectively.

13. The image coding method according to claim 8, wherein the interimage transforming step separates the plurality of input images into low frequency components and high frequency components and further separates the low frequency components into low frequency components and high frequency components.

14. The image coding method according to claim 8, wherein the interimage transforming step separates the plurality of input images into low frequency components and high frequency components and further separates the high frequency components into their respective low frequency components and high frequency components.

15. The image coding apparatus according to claim 1, wherein the interimage transforming section separates by wavelet transformation.

16. The image coding method according to claim 8, wherein the interimage transforming step separates the input images by wavelet transformation.

17. The image coding apparatus according to claim 3, further comprising a quantizing section which quantizes by separately controlling a quantizing parameter of the high frequency images among the plurality of images corresponding to predetermined spatial frequency bands output from the intraimage transforming section.

18. The image coding apparatus according to claim 17, wherein the quantizing section determines the quantizing parameter of the high frequency images rough as compared with the quantizing parameter of the low frequency images.

19. The image coding method according to claim 10, further comprising a quantizing step, which quantizes by separately controlling the quantizing parameters of the high frequency images among the plurality of images corresponding to predetermined spatial frequency bands obtained by the intraimage transforming step.

20. The image coding method according to claim 19, wherein the quantizing step determines the quantizing parameter of the high frequency images rough as compared with the quantizing parameter of the low frequency images.
